(19) United States
(12) Patent Application Publication
(10) Pub. No.: US 2014/0184466 A1
(43) Pub. Date: Jul. 3, 2014

(54) COMMUNICATION DEVICE AND ANTENNA ELEMENT THEREIN

(71) Applicant: ACER INCORPORATED, Taipei Hsien (TW)

(72) Inventors: Kin-Lu WONG, Taipei Hsien (TW); Yi-Ting HSIEH, Taipei Hsien (TW)

(73) Assignee: ACER INCORPORATED, Taipei Hsien (TW)

(21) Appl. No.: 13/781,598

(22) Filed: Feb. 28, 2013

(30) Foreign Application Priority Data
Jan. 3, 2013 (TW) 102100075

(51) Int. Cl. H01Q 21/30; H01Q 1/50

(52) U.S. Cl. CPC H01Q 21/30; H01Q 1/50
USPC 343/860; 343/700 MS

(57) ABSTRACT

A communication device including a ground element and an antenna element is provided. The antenna element is close to the ground element. The antenna element includes a first radiation element and a second radiation element. The first radiation element provides a first current path and operates in a first band. The second radiation element provides a second current path and operates in a second band. The frequencies of the second band are higher than those of the first band, and the length of second current path is greater than that of first current path.

### CROSS REFERENCE TO RELATED APPLICATIONS

This Application claims priority of Taiwan Patent Application No. 102100075 filed on Jan. 3, 2013, the entirety of which is incorporated by reference herein.

### BACKGROUND OF THE INVENTION

1. Field of the Invention

The disclosure generally relates to a communication device, and more particularly, relates to a communication device comprising a multi-band ground plane antenna.

2. Description of the Related Art

With recent, rapid development in wireless communication technology, users require communication devices for not only talking but also having a variety of functions. To satisfy the requirements of users and to maintain thin and light appearance of a communication device, it is important for an antenna designer to make effective use of the limited space inside the communication device.

As a result, it is hence a challenge for an antenna designer to design a ground plane antenna in a limited space, to make the ground plane antenna generate a ground plane mode effectively for antenna radiation, and to reduce the total area occupied by the antenna.

### BRIEF SUMMARY OF THE INVENTION

The invention aims to provide a communication device with a multi-band ground plane antenna. The communication device comprises an antenna element, and the antenna element comprises two different radiation elements so as to operate in low and high communication bands. In the invention, the length of a current path of a low-band radiation element is smaller than that of a high-band radiation element such that the size of the multi-band antenna element can be minimized.

In a preferred embodiment, the invention provides a communication device, comprising: a ground element; and an antenna element, close to the ground element, wherein the antenna element comprises: a first radiation element, providing a first current path and operating in a first band; and a second radiation element, providing a second current path and operating in a second band, wherein frequencies of the second band are higher than frequencies of the first band, and the length of the second current path is greater than the length of the first current path.

Note that when the antenna element resonates in a low band, the ground plane provides 90% or more radiation efficiency. If surface currents on the ground plane are effectively excited to generate a ground plane mode to cover the desired bandwidth, the size of the antenna element for operating in the low band may be significantly reduced. As mentioned above, the invention uses the small antenna element as an exciter to excite surface currents on the ground plane such that the ground plane resonates and generates a ground plane mode to achieve low-band operations. The antenna element of the invention not only has a small size but also maintains good radiation performance.

In some embodiments, the antenna element has a size of about 8×25 mm², and the first radiation element has a size of about 8×10 mm² With the small structure, the antenna element can operate in at least GSM850/900/1800/1900/UMTS/LTE2300/2500 bands.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment of the invention;

FIG. 2 is a diagram for illustrating S-parameters of an antenna element of a communication device according to the first embodiment of the invention;

FIG. 3 is a diagram for illustrating antenna efficiency of an antenna element of a communication device according to the first embodiment of the invention;

FIG. 4 is a diagram for illustrating a communication device according to a second embodiment of the invention;

FIG. 5 is a diagram for illustrating a communication device according to a third embodiment of the invention; and

FIG. 6 is a diagram for illustrating a communication device according to a fourth embodiment of the invention.

### DETAILED DESCRIPTION OF THE INVENTION

In order to illustrate the foregoing and other purposes, features and advantages of the invention, the embodiments and figures thereof in the invention are described in detail as follows.

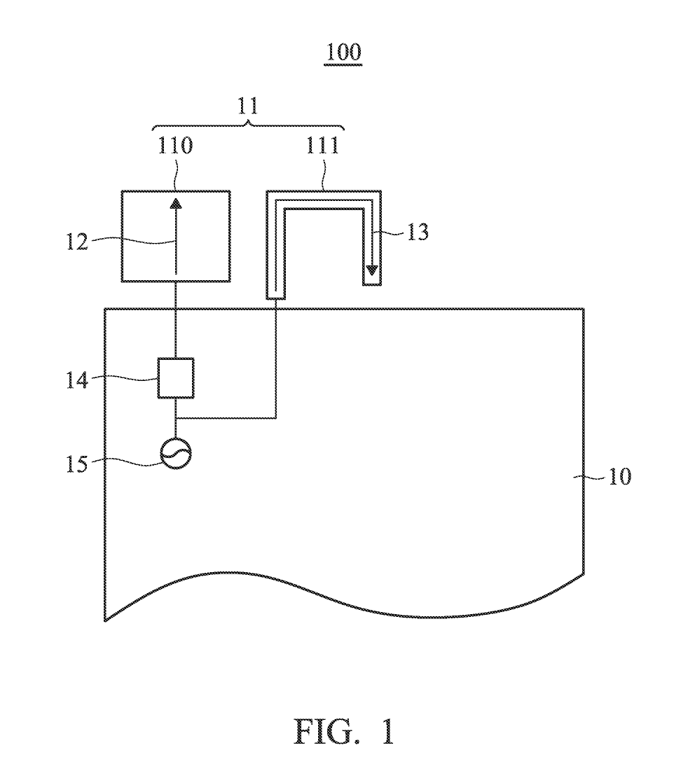

FIG. 1 is a diagram for illustrating a communication device 100 according to a first embodiment of the invention. For example, the communication device 100 may be a mobile phone, a tablet computer, or a notebook computer. As shown in FIG. 1, the communication device 100 comprises a ground element 10 and an antenna element 11. The antenna element 11 is close to the ground element 10, and is excited by a signal source 15. The antenna element 11 comprises a first radiation element 110 and a second radiation element 111. The first radiation element 110 is substantially separated from the second radiation element 111. The first radiation element 110 provides a first current path 12, and operates in a first band. The second radiation element 111 provides a second current path 13, and operates in a second band. In a preferred embodiment, the frequencies of the second band are higher than those of the first band, and the length of the second current path 13 is greater than that of the first current path 12. In some embodiments, the length of the first current path 12 is smaller than 0.1 wavelength of the lowest frequency of the first band. In some embodiments, the first radiation element 110 is further coupled to a matching circuit 14, and the matching circuit 14 comprises at least a band-pass circuit (or a reactance circuit), such as a band-pass filter comprising one or more capacitors and inductors, to optimize the impedance matching for the input impedance in the first band (low band). In some embodiments, the second radiation element 111 is a monopole antenna. In some embodiments, the first radiation element 110, the second radiation element 111, and the ground element 10 are disposed on a dielectric substrate (not shown), which may be flexible and suitably applied to a flexible communication device. Note that the communication device 100 may further comprise other components, such as a touch panel, a touch module, a processor, a speaker, an RF (Radio Frequency) module, a battery, and a housing (not shown). Generally, a low-band radiation element of a conventional antenna should be designed to have a specific resonant length (e.g., a quarter wavelength). In comparison, the invention provides the ground plane antenna which can effectively excite a ground plane mode to improve radiation, thereby reducing the size of the low-band radiation element (i.e., the first radiation element 110) to about 0.1 wavelength. In addition, the invention may incorporate the matching circuit 14 appropriately to optimize the impedance matching for the input impedance in the low band and to cover the desired low-band bandwidth.

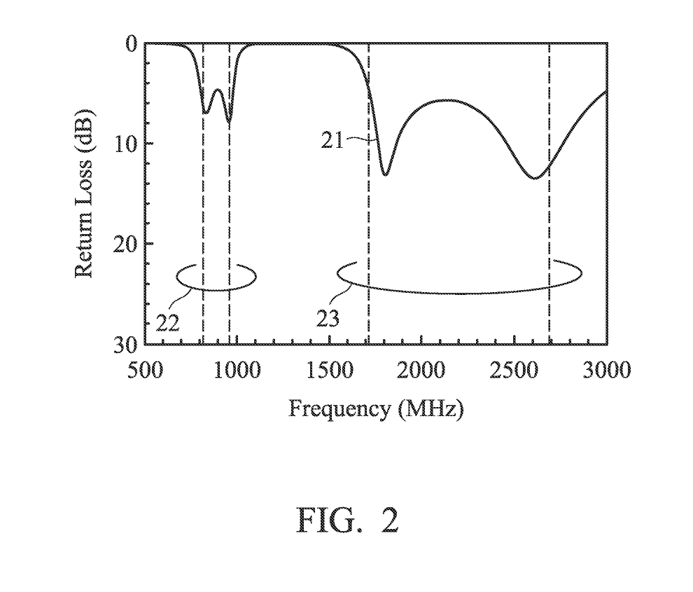

FIG. 2 is a diagram for illustrating S-parameters of the antenna element 11 of the communication device 100 according to the first embodiment of the invention. In some embodiments, element sizes of the communication device 100 are as follows. The antenna element 11 (including the first radiation element 110 and the second radiation element 111) merely has a total size of about 8×25 mm² The first radiation element 110 is substantially a rectangular metal plate, and has a size of about 8×10 mm² The second radiation element 111 is substantially an inverted U-shaped metal plate, and the current path thereof has a length of about 28 mm. The ground element 10 has a size of about 120×60 mm² As shown in FIG. 2, according to the reflection coefficient (S₁₁) curve 21 of the antenna element 11, the antenna element 11 can operate in a first band 22 and a second band 23. The bandwidth of the first band 22 covers at least GSM850/900 bands (from about 824 MHz to 960 MHz), and the bandwidth of the second band 23 covers at least GSM1800/1900/UMTS/LTE2300/2500 bands (from about 1710 MHz to 2690 MHz).

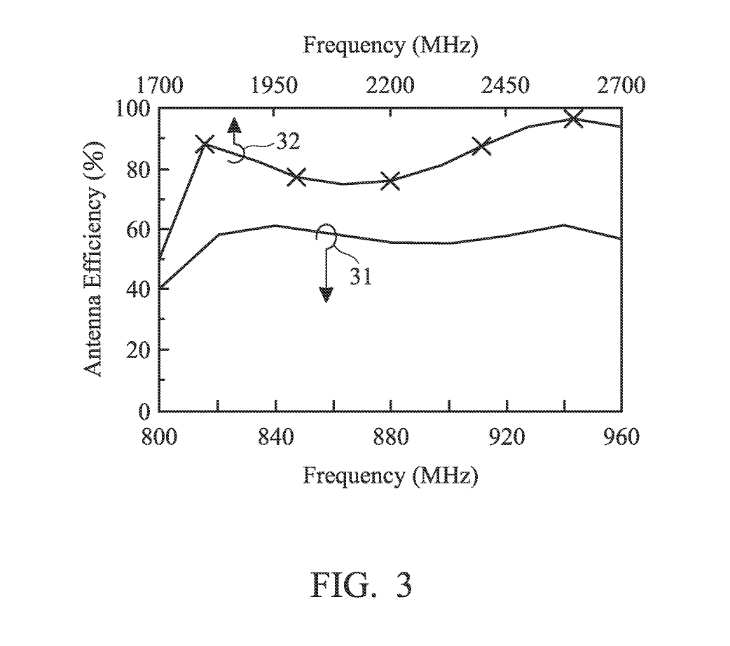

FIG. 3 is a diagram for illustrating antenna efficiency of the antenna element 11 of the communication device 100 according to the first embodiment of the invention. According to the antenna efficiency curve 31 (mismatching losses included in the antenna efficiency) of the antenna element 11, the antenna efficiency of the antenna element 11 is approximately from 54% to 61% in the first band 22. According to the antenna efficiency curve 32 (mismatching losses included in the antenna efficiency) of the antenna element 11, the antenna efficiency of the antenna element 11 is approximately from 50% to 95% in the second band 23. As a result, the antenna element 11 has good antenna efficiency in both the first band 22 and the second band 23, meeting the requirements of practical applications.

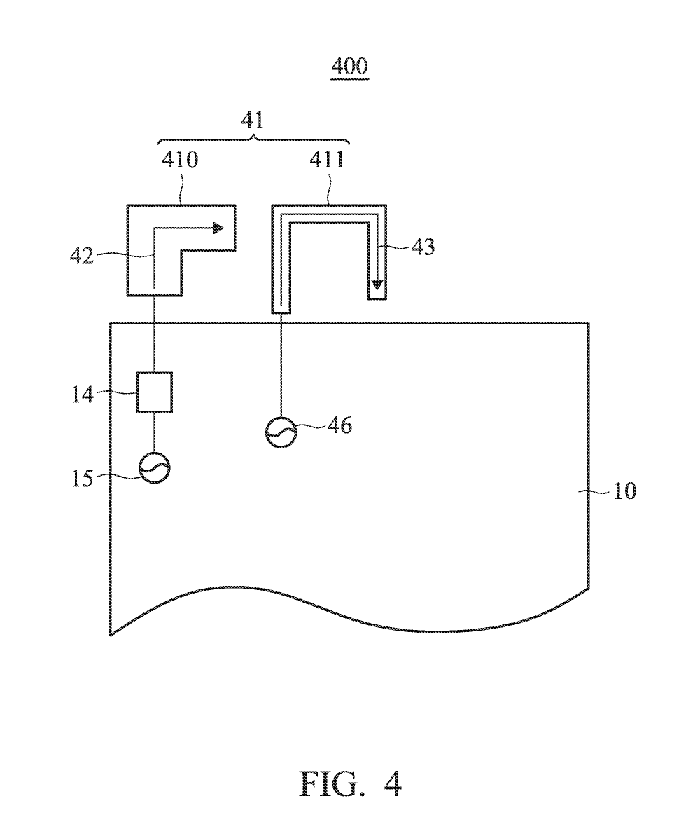

FIG. 4 is a diagram for illustrating a communication device 400 according to a second embodiment of the invention. The second embodiment is basically similar to the first embodiment. The difference between the two embodiments is that in an antenna element 41 of the communication device 400, a first radiation element 410 substantially has an inverted L-shape. In addition, in the communication device 400, the first radiation element 410 and a second radiation element 411 are respectively coupled to a signal source 15 and another signal source 46, instead of being both coupled to a single signal source. In the embodiment, the length of a second current path 43 of the second radiation element 411 is still greater than that of a first current path 42 of the first radiation element 410. Other features of the communication device 400 in the second embodiment are the same as those of the communication device 100 in the first embodiment. Accordingly, the two embodiments can achieve similar performances.

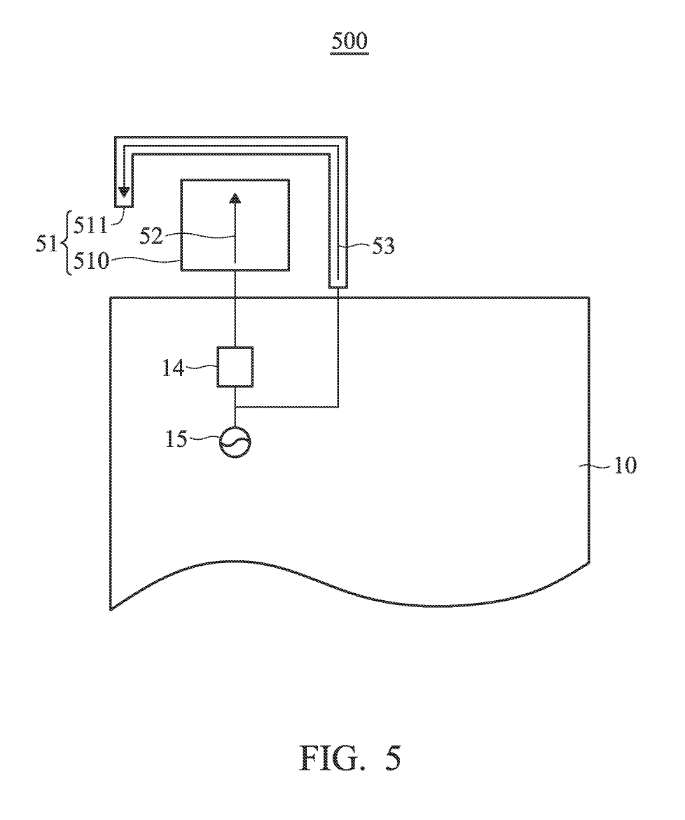

FIG. 5 is a diagram for illustrating a communication device 500 according to a third embodiment of the invention. The third embodiment is basically similar to the first embodiment. The difference between the two embodiments is that in an antenna element 51 of the communication device 500, a second radiation element 511 extends to surround a first radiation element 510. In other words, the first radiation element 510 is substantially surrounded by the second radiation element 511 and the ground element 10. As a result, the total space occupied by the first radiation element 510 and the second radiation element 511 becomes smaller such that the total size of the antenna element 51 is minimized. In some embodiments, the second radiation element 511 substantially has an inverted J-shape. In the embodiment, the length of a second current path 53 of the second radiation element 511 is still greater than that of a first current path 52 of the first radiation element 510. Other features of the communication device 500 in the third embodiment are the same as those of the communication device 100 in the first embodiment. Accordingly, the two embodiments can achieve similar performances.

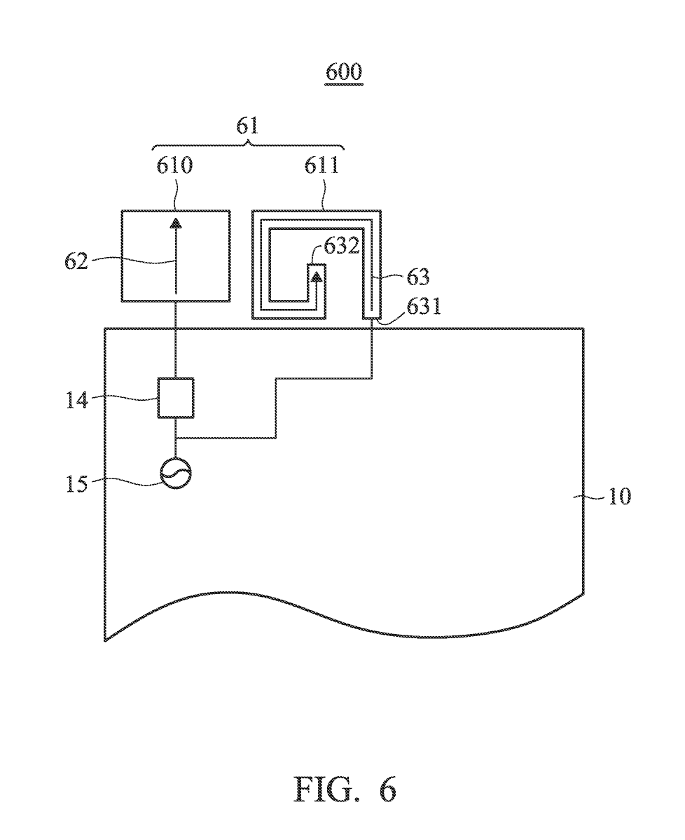

FIG. 6 is a diagram for illustrating a communication device 600 according to a fourth embodiment of the invention. The fourth embodiment is basically similar to the first embodiment. The difference between the two embodiments is that in an antenna element 61 of the communication device 600, a feeding end 631 (a region with strong currents and weak electric fields) of a second radiation element 611 is outward, and an open end 632 thereof (another region with null currents and strong electric fields) is inward. As a result, the antenna element 61 tends to be integrated with nearby circuits, electronic components, and/or metal surfaces. In some embodiments, the second radiation element 611 substantially has an inverted G-shape. In the embodiment, the length of the second current path 63 of the second radiation element 611 is still greater than that of the first current path 62 of the first radiation element 610. Other features of the communication device 600 in the fourth embodiment are the same as those of the communication device 100 in the first embodiment. Accordingly, the two embodiments can achieve similar performances.

The invention proposes a novel mobile communication device. By designing a low-band radiation element of an antenna element as a small-size element, a ground plane antenna formed by the small-size element and a ground element of the mobile communication device may be successfully excited to cover a desired low band. Note that the invention is not required to design the low-band radiation element according to a specific resonant length as mentioned in prior art. The invention may incorporate a matching circuit appropriately to optimize the impedance matching for input impedance in the low band. The invention may further incorporate a high-band radiation element to cover a desired high band without affecting the low-band radiation element. In this case, the antenna element can achieve multi-band operations. Since the resonant length of the low-band radiation element of the antenna element is significantly reduced (e.g., the resonant length of the low-band radiation element is smaller than that of the high-band radiation element), the total size of the antenna element is minimized, and the antenna element is suitably applied to a variety of small mobile communication devices.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element; and
an antenna element, close to the ground element, wherein the antenna element comprises:
a first radiation element, providing a first current path, and operating in a first band; and
a second radiation element, providing a second current path, and operating in a second band,
wherein frequencies of the second band are higher than frequencies of the first band, and a length of the second current path is greater than a length of the first current path.

2. The communication device as claimed in claim 1, wherein the first radiation element is further coupled to a matching circuit.

3. The communication device as claimed in claim 2, wherein the matching circuit comprises at least a band-pass circuit.

4. The communication device as claimed in claim 1, wherein the second radiation element is a monopole antenna.

5. The communication device as claimed in claim 1, wherein the length of the first current path is smaller than 0.1 wavelength of the lowest frequency of the first band.

6. The communication device as claimed in claim 1, wherein the first radiation element is substantially separated from the second radiation element.

7. The communication device as claimed in claim 1, wherein the first radiation element, the second radiation element, and the ground element are disposed on a dielectric substrate.

8. The communication device as claimed in claim 7, wherein the dielectric substrate is flexible.

9. The communication device as claimed in claim 1, wherein the first radiation element substantially has a rectangular shape.

10. The communication device as claimed in claim 1, wherein the first radiation element substantially has an inverted L-shape.

11. The communication device as claimed in claim 1, wherein the second radiation element substantially has an inverted U-shape.

12. The communication device as claimed in claim 1, wherein the second radiation element substantially has an inverted G-shape.

13. The communication device as claimed in claim 1, wherein the first radiation element is substantially surrounded by the second radiation element and the
